(19) United States
(12) Patent Application Publication
(10) Pub. No.: US 2025/0376815 A1
(43) Pub. Date: Dec. 11, 2025

(54) DEVICE FOR LEVELING MATERIAL

(71) Applicant: Christopher Michael Patterson, Coeur d'Alene, ID (US)

(72) Inventor: Christopher Michael Patterson, Coeur d'Alene, ID (US)

(21) Appl. No.: 18/735,363

(22) Filed: Jun. 6, 2024

(51) Int. Cl. E01C 23/082; B25G 1/04

(52) U.S. Cl. CPC E01C 23/082; B25G 1/04

(57) ABSTRACT

Techniques of the disclosure herein relate to a device for leveling material that can be efficiently and conveniently be employed by a user of any experience level. More specifically, the device may comprise a handle and an elongated head with at least a partially cylindrical cross section (or cylindrical head) that is configured to contact and distribute the material. The device may comprise an attachment mechanism to couple the elongated head to the handle that may comprise at least two support braces that couple the elongated head to the handle. The device reduces the training, guidance, and time required to reset a sand pit in between long jump attempts, for example, and can be used accurately and effectively by an individual with any level of experience.

### BACKGROUND

Recreational activities and sports such as golf, track and field, volleyball, baseball, and others may be conducted at least in part on a surface subject to unevenness, variation, or redistribution (e.g., sand, dirt, gravel). Some activities/sports (e.g., volleyball) may not need a playing surface that is as smooth/level as others (e.g., track and field or golf). There are various devices that may be used to smooth, level, or grade the playing surface of a recreational activity. However, such devices may be limited in their usability, accuracy, efficiency, and/or convenience.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates an example device for leveling material, according to examples of the present disclosure.

FIG. 2 illustrates an exploded view of the example device of FIG. 1, according to examples of the present disclosure.

FIGS. 3A and 3B illustrate a horizontal frontal view and a horizontal rear view of the example device of FIG. 1, according to examples of the present disclosure.

FIG. 4 illustrates a horizontal side view of the example device of FIG. 1, according to examples of the present disclosure.

FIGS. 5A and 5B illustrate a top-down view and a bottom-up view of the example device of FIG. 1 respectively, according to examples of the present disclosure.

FIG. 6 illustrates an enlarged view of an elongated head of the example device of FIG. 1, according to examples of the present disclosure.

FIG. 7 illustrates an example device, according to examples of the present disclosure.

FIGS. 8A, 8B, and 8C illustrate example devices, according to examples of the present disclosure.

FIGS. 9A and 9B illustrates example elongated heads of the example device of FIG. 1, according to examples of the present disclosure.

### DETAILED DESCRIPTION

As discussed briefly above, myriad sports and recreational activities may be played or conducted in whole or in part on a surface that may be subject to unevenness, variation, and/or redistribution. Golf, volleyball, track and field (e.g., shotput, long jump, triple jump, etc.), footvolley, beach handball, baseball, rodeo (e.g., bull/bronco riding, barrel racing, etc.) are just some examples of activities that may be performed on a surface subject to unevenness or irregularities. For example, long jump and triple jump events in track and field are typically competed on and measured using a sand pit. Similarly, golf courses may include one or more sand traps designed to increase the difficulty and/or improve the aesthetic experience of a round of golf. As another example, baseball may be played in whole or in part on a dirt field that may have portions subject to increased wear and tear and may therefore have more non-level, irregular surfaces. Notwithstanding the activity, some sports may be more accurate, fair, safe, and/or aesthetic when the surface on which they are conducted is level (for the sake of simplicity, “level” will be used throughout to describe a surface that may be graded, flat, and/or even) and/or textured (e.g., smooth, corrugated, etc.). For example, in the context of a long jump event in track and field, an uneven or non-level sand pit may unfairly advantage (or disadvantage) certain athletes since the distance the athlete jumps is generally measured from the point in the sand pit where the athlete landed. If the sand in the sand pit is not level, some athletes may be at an advantage (or disadvantage) because the unevenness may allow for the athletes to achieve a greater (or shorter) height above the sand, thereby increasing (or decreasing) the distance the athlete covers in the air before landing in the sand pit. That is, a sloped or uneven pit may mean an athlete spends more (or less) time in the air, which may translate to a longer (or shorter) distance jumped. In other examples, sand traps on a golf course may be textured (e.g., smooth, corrugated, or otherwise patterned) to improve the tidiness of the sand trap and/or increase the overall aesthetic quality of the golf course or hole.

In each of these examples, a user, athlete, and/or referee is typically tasked with leveling the surface after each jump, chip, or at one or more times before, during, and/or after competition or use of the playing surface (e.g., sand pit, court, field, etc.). Conventional methods of leveling these surfaces can be difficult for novice users to employ effectively and efficiently, may require increased time or energy even for experienced users, and/or may be inconvenient for certain applications that require thorough and/or precise leveling. For example, in the context of long or triple jump track and field events, competitions and meets generally involve referees (or volunteers) who are tasked with monitoring, measuring, and/or resetting/releveling the sand after an athlete disturbs the surface during a jump. In order to maintain a level surface and avoid giving any particular athlete or location an advantage as discussed above, referees or volunteers are generally given a tool or device that can require hours, even years of training and guidance to properly use. Novice users of conventional devices for leveling material after an athlete's jump or shot may be ill-equipped to level the material accurately and efficiently. For example, a novice user employing conventional techniques and/or devices for leveling sand after long jump attempts may be inaccurate or incomplete by a small margin (e.g., fractions of an inch) which may, over the course of a meet, competition, or season, add up to a much more substantial margin (e.g., an inch or more) of incompleteness or inaccuracy, which may prejudice or advantage athletes who jump later in the meet, competition, or season. Further, novice or advanced users of conventional methods for leveling a sand pit or other material may, despite their experience, require an amount of time to level (i.e., reset) the sand pit that exceeds an ideal or scheduled amount of time. For example, in the context of leveling a sand pit after a long jump athlete disturbs the sand, a user who requires an additional duration (e.g., 3 seconds, 10 seconds, 45 seconds, etc.) may, over the course of the meet or competition, cause a substantial amount of time (e.g., minutes or hours) to be added to the overall length of the competition. Relatedly, an increased duration in between events or occurrences (e.g., between athletes jumping, golfers moving on to the next hole) may introduce considerable lag or inefficiencies into the operation of the event or competition and may slow the timetable/schedule allocated for each event or instance. Additional time to level the sand pit or other material may also be frustrating for the athletes who have to wait longer durations in between attempts, thereby directly impacting the flow of the competition and patience of all those involved (e.g., athletes, coaches, referees, spectators, etc.).

Additionally or alternatively, conventional devices for leveling material may be inconvenient or imprecise for certain applications that require thorough and/or detailed leveling. For example, in the context of sand pits in track and field, competitions may be won or lost, records broken or maintained, and/or podium positions attained or missed by mere fractions of a measurement (e.g., inch, centimeter). Accurately, completely, and thoroughly leveling the sand in such situations becomes of significant importance to ensure a fair and precise competition. Even when used properly by experienced users, conventional devices for leveling sand and thereby resetting the sand pit typically leave patterns, lines, and/or textures, which can introduce a confusing, inaccurate, or otherwise flawed surface on which the athlete's jump is measured by referees or otherwise. Similarly, in the context of golf, contacting bunker sand with the club prior to making a stroke may be a violation of the rules, and the patterns, lines, and/or disturbances left by conventional devices may muddy the waters as to whether a golfer violated the rules by contacting the sand before their stroke.

Further, the problems discussed herein may compound on one another and create additional inefficiencies, delays, and/or prejudices between athletes, teams, locations, etc. For example, a novice user of a conventional device for leveling material may do so inaccurately which may then require a more experienced user to take over and fix the problem, adding even more time in between events or instances in addition to the flawed surface introduced by the novice user. Once the competition and/or meet is delayed due to user inefficiency or inaccuracy, it can be difficult or impossible to get back on schedule. Additionally, such delays or inefficiencies may throw off the rhythm or concentration of the athletes, meaning the novice user's application of the conventional device may directly impact the competitive integrity of the event or meet. Relatedly, introducing delays in between jumps or instances may increase the possibility of injury to an athlete because the athlete(s) may be forced to stand around and wait for the material to be leveled before their turn or heat. Such waiting may result in tightened muscles and ligaments, decreased concentration, etc., which may increase the chances of injury.

Techniques of the disclosure herein relate to a device that is accurate and easy to use for individuals of all experience levels, requires less time and energy to achieve a level surface, and is designed to be just as effective on surfaces that need to be meticulously and precisely leveled as it is on surfaces that may not be leveled as thoroughly. For example, an elongated head having at least a partially cylindrical cross section (e.g., a cylindrical or ovular head, etc.) may provide a consistent surface/contact area with the material to be leveled and distributed such that no training or guidance on how to level material with the device is required. Further, the elongated head may ensure that with very little change in downward pressure, the user can quickly move/distribute material bidirectionally, thereby decreasing the amount of time or the number of passes it takes to achieve level surface. Additionally or alternatively, the elongated head may comprise a smooth outer surface contour and/or the terminal ends of the elongated head may have chamfered, rounded, or beveled edges to reduce or altogether eliminate the lines/disturbances left by conventional devices. Such features allow a user of any experience level to achieve a uniform and precise material surface. The usability, efficiency, and convenience of devices described herein also give a user of any experience level greater control over the material being leveled. Furthermore, in some examples, devices described herein may be lighter weight than conventional rakes or other implements, thereby reducing fatigue of a user, especially over numerous uses or instances.

As discussed in more detail below, some implementations of the disclosure herein relate to a device comprising a handle and a cylindrical head, or an elongated head having at least a partially cylindrical cross section, coupled to the handle by an attachment mechanism and configured to contact and distribute a material. In some examples, the handle may extend in a first direction (along a length of the handle) to allow a user to increase or decrease the length of the handle and may be aligned with a center or medial portion of the elongated head and be offset vertically relative to a longitudinal axis of the elongated or cylindrical head. The elongated or cylindrical head may extend in a first longitudinal direction and/or a second longitudinal direction opposite the first longitudinal direction. In some examples, the first longitudinal direction and second longitudinal direction are orthogonal relative to the first direction. The elongated or cylindrical head may be configured to contact and distributed the material, as discussed in more detail below. The attachment mechanism that couples the elongated or cylindrical head to the handle may comprise a first brace angularly coupled to the handle and to a first portion of the elongated or cylindrical head and a second brace angularly coupled to the handle and to a second portion of the elongated or cylindrical head. In some examples, the first portion is positioned in the first longitudinal direction and the second portion is positioned in the second longitudinal direction. The first brace and second brace may ensure a sturdy and durable design such that it can be used many times over without losing its structural integrity or convenience. In some examples, the device may additionally or alternatively comprise a center support or brace configured to couple a terminal end of the handle in a second direction opposite the first direction to the elongated or cylindrical head.

In some examples, the elongated or cylindrical head may comprise a smooth outer contour configured to evenly level and distribute material by a user. In other examples, the elongated or cylindrical head may comprise a corrugated or dimpled outer contour configured to impress or leave a design in the material in addition to or in lieu of leveling it flat (e.g., golf sand trap, etc.). In other examples, one or more of a first terminal end or a second terminal end of the elongated head may be enclosed. Having one or more enclosed terminal ends may ensure the device avoids capturing or collecting material inside of the elongated or cylindrical head to avoid unnecessary weight and thereby help reduce user fatigue. In at least some examples, the first terminal end and/or second terminal end of the elongated or cylindrical head may further comprise a chamfered, radiused, or beveled edge, or a domed surface to prevent the elongated or cylindrical head from leaving a line or disturbance in the material. Additionally or alternatively, the handle may be configured to extend in the first direction and increase the length of the device, thereby allowing a user to reach further distances with reduced effort and less time. In some examples, the handle may comprise measurement indicators that may be used by an athlete, referee, or volunteer to measure the distance of a jump, for example. As a more concrete example, a user of the device who is practicing or training may not have access to laser-assisted measurement technology that may be used in a competition or meet setting. In such an example, the measurement indicators disposed on the handle at regular intervals may allow a user to accurately measure the distance of their jumps without the use of additional materials or equipment.

Additional and alternative examples are described herein. Although many of the examples presented are in the context of track and field events for the sake of clarity, an ordinarily skilled artisan will appreciate that the device and disclosure herein may be applied to myriad sports, activities, and/or endeavors. For example, the devices and techniques described here may be used in any activity that is played or conducted on a surface subject to unevenness, variation, or redistribution (e.g., sand on a beach volleyball or footvolley court, dirt on a baseball diamond or rodeo arena, gravel on a bocce ball court or horseshoe pit, and so on). Additionally, any one or more features or components described herein may be used in addition to, or in lieu of, any one or more other features or components depending on the use case, activity, and/or other circumstances.

### Example Device

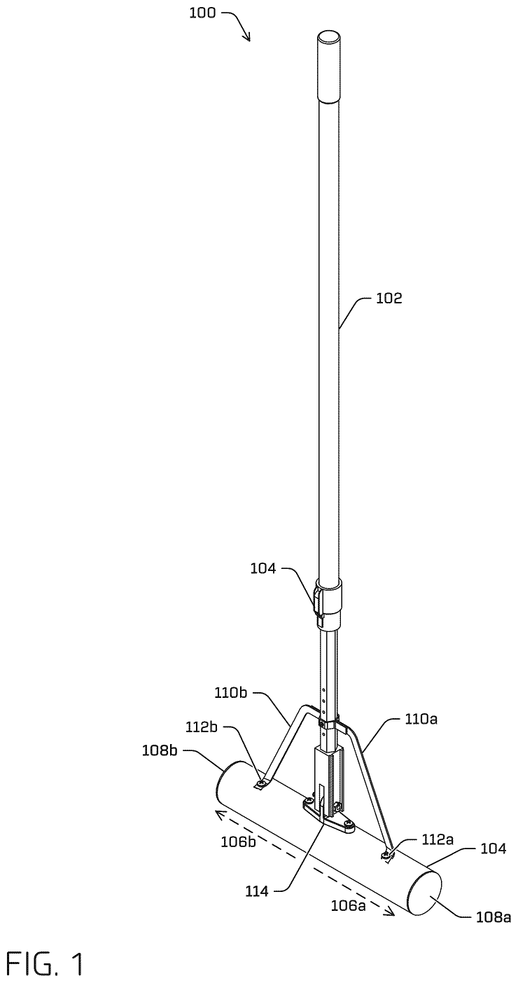

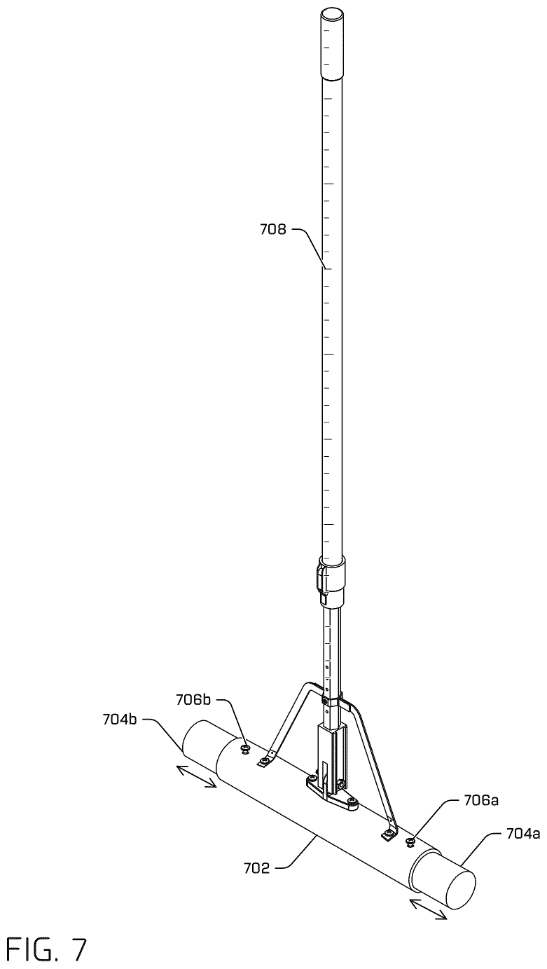

FIG. 1 illustrates an example device 100 for leveling material, according to examples of the present disclosure. Example device 100 may comprise a handle 102 extending in a first direction. The handle may be configured to extend in the first direction to increase a length of the handle, thereby increasing the reach of example device 100. As discussed in more detail with regard to FIG. 7, the handle 10 may further comprise measurement indicators at regular intervals. The construction of the handle 102 may comprise one or more of wood (e.g., ash, beech, hickory, maple, oak, etc.), metal (e.g., aluminum, steel, etc.), plastic (e.g., high-density polyethylene (HDPE), polypropylene, acrylonitrile butadiene styrene ABS), polyvinyl chloride (PVC), etc.), and/or composite (e.g., carbon fiber reinforced polymer, fiberglass reinforced plastic, wood-plastic composite, aluminum composites, etc.). The handle 102 may, in some examples, comprise one or more grips or paddings at or near a terminal (or distal) end in the first direction of the handle 102 and/or at one or more locations along its length, to improve usability, decrease user fatigue, and/or to increase a user's control of the example device 100.

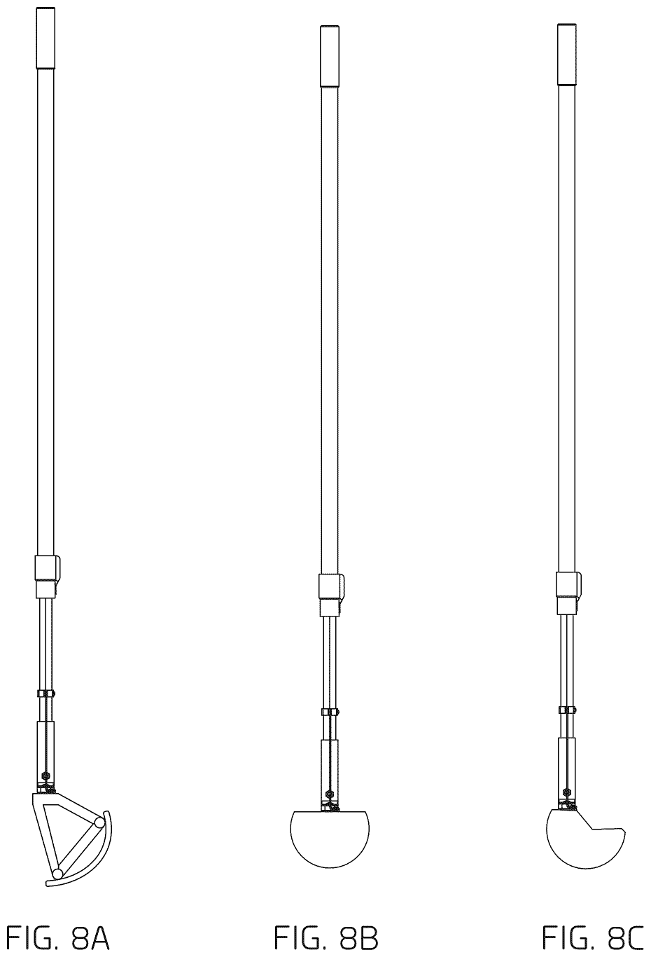

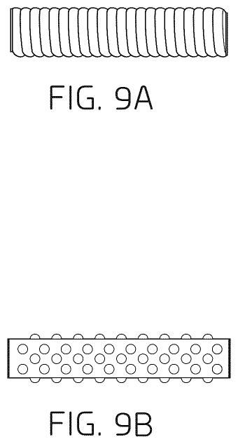

Example device 100 may further comprise an elongated head 104 having at least a partially cylindrical cross section configured to contact and distribute a material (e.g., sand, dirt, gravel, etc.) as discussed above. As depicted, the elongated head 104 may comprise a cylindrical or partially cylindrical shape. In some examples, elongated head 104 may comprise an arcuate cross section, or any other similarly rounded surface/contour that is configured to contact the material (e.g., ovular, etc.). For the sake of clarity and readability, the head of example device 100 will be referred to hereinafter as elongated head 104. Additional examples and details of elongated heads according to this disclosure are described below with regard to FIGS. 8A, 8B, 8C, 9A, and 9B. As depicted, the elongated head 104 may extend in a first longitudinal direction 106a and a second longitudinal direction 106b opposite the first longitudinal direction 106a. In some examples, the elongated head 104 may extend from a central plane in the first longitudinal direction 106a between 6 and 18 inches, and/or may extend in the second longitudinal direction 106b between 6 inches and 18 inches, thereby giving the elongated head 104 a total width between 12 inches and 36 inches. In some instances, the elongated head may comprise an overall width greater than 36 inches, and/or may comprise an overall width less than 12 inches. As a nonlimiting example, in the context of a beach volleyball court, the elongated head 104 of example device 100 may comprise a width substantially greater than 36 inches (e.g., 3 feet, 6 feet, 12 feet, etc.) in order to increase the surface area of the elongated head 104 that contacts the material to more efficiently level the sand of the larger surface. As another nonlimiting example, the overall width of the elongated head 104 may be less than 12 inches for use with activities associated with smaller surface areas such as a gravel surface in a horseshoe pit or bocce ball court. In such examples, the smaller playing surface area of the activity may make an elongated head 104 with a smaller width more practical or convenient for storage, maneuverability, and/or usability purposes. As discussed in more detail below with regard to FIG. 7, the elongated head 104 may be extendible and may comprise one or more body components configured to extend in the first longitudinal direction 106a and/or the second longitudinal direction 106b to improve customizability and convenience for a user's specific needs or preferences. By way of example and not limitation, in the case of an extendible elongated head, the body component(s) may slide (e.g., telescope) on the inside or outside of a central body portion of the elongated head 104, and may extend a distance up to about half of the width of the central body portion (e.g., the body component(s) may extend up to 18 inches in the case of a 36 inch wide central body portion, or up to 12 inches in the case of a 24 inch wide central body portion).

In some examples, the construction of the elongated head 104 may comprise any one or more materials sufficient to withstand wear and tear, environmental stressors, and/or continued or repetitive use over time. For example, the elongated head 104 of example device 100 may comprise any one or more plastics (e.g., high-density polyethylene (HDPE), polypropylene, acrylonitrile butadiene styrene (ABS), polyvinyl chloride (PVC), thermosetting polymer, etc.), metals (e.g., aluminum, steel, etc.), woods (e.g., ash, beech, pine, etc.), composites (e.g., carbon fiber, fiberglass, carbon fiber reinforced polymer, fiberglass reinforced plastic, wood-plastic composite, aluminum composites, wire-mesh reinforced fiberglass, etc.), or any combination thereof. Such materials or combinations may provide various benefits for various use cases or circumstances. As a nonlimiting example, HDPE or ABS may provide a preferred combination of durability for applications with sand, reduced weight for reduced user fatigue and improved convenience, and/or availability/value of the device or replacement parts. As another nonlimiting example, an elongated head 104 comprised of one or more metals may provide greater durability for harsher materials that subject the elongated head 104 to increased wear and tear (e.g., gravel or rocks), increased usability with tractors or similar machinery (e.g., example device 100 may be drug behind a tractor or similar machine to level the dirt of a baseball field), increased weight to limit how much downward pressure a user needs to apply, etc. In some examples, the elongated head 104 may be hollow to reduce the weight of example device 100 and thereby improve usability and convenience. In other examples, the elongated head 104 may comprise a solid material to avoid collecting material inside of the elongated head 104 or to increase the weight of the elongated head 104 such that downward force/pressure applied to a material is increased, thereby contacting the material with greater force/surface area and distributing more material than a lighter elongated head 104 might.

Different cross-sectional dimensions of the elongated head 104 may provide different benefits depending on the material(s) that comprise the elongated head 104. For example, if the dimensions of the elongated head 104 are greater, but the weight of the material comprising the elongated head 104 is relatively light, the surface area that contacts the material may be smaller to prevent burdensome drag or inefficiencies to a user, thereby reducing user fatigue and improving usability. In another example, the material comprising the elongated head 104 may heavier/denser (e.g., metal, etc.) which may allow for an elongated head 104 with a different cross-sectional dimension or width without sacrificing effectiveness. In such an example, the heavier material may cause the elongated head 104 to apply a greater downward force as it is applied, which may allow the elongated head 104 to have a smaller diameter or overall width without sacrificing effectiveness or levelness. As demonstrated by such examples, the material comprising the elongated head 104, along with the cross sectional dimension, weight, and width of the elongated head 104 may be altered in numerous combinations to provide myriad combinations of usability, convenience, efficiency, drag or surface area, etc. to meet the specific needs of any given use case. Though various different examples are provided, it should be understood that features of any example may be combined with features of any one or more other examples described herein. In some examples, the weight of the elongated head may be between two and twenty pounds. Depending on the size, construction, materials, etc., the weight of the elongated head and/or the weight of the overall device may vary. Such a weight may provide sufficient downward force applied to the material in addition to or in lieu of a user applying downward pressure during use to evenly and efficiently distribute or level the material, while minimizing the strain and fatigue of users and allowing the device to be effectively used by smaller adults and/or youth.

In other examples, a heavier weight may improve the efficiency of leveling the material by reducing how much downward pressure a user must apply in order to level the material quickly and accurately. Such may be the case, for example, in the context of a baseball field or a horseshoe pit, where the material to be leveled (e.g., dirt, clay, gravel, etc.) is heavier and/or harder to manipulate than sand may be, for example. A heavier elongated head 104 may allow a user to drag example device 100 across the material without applying much, if any, downward force. In another example in the context of golf, a sand trap or bunker may be hard to access from certain angles or approaches because of the design, depth, slope, or edge shape of the sand trap or of the surrounding course area. In such an example, a lighter or less dense material may be beneficial because it may allow a user to more easily manipulate the angle at which and direction from which they apply the device to the material. Further, a lighter device in such an example may allow a user to carry the device more easily to a different slope, approach, or entry/exit of the bunker and thus improve the convenience of using the device to level the sand in the bunker without excessive energy or complication.

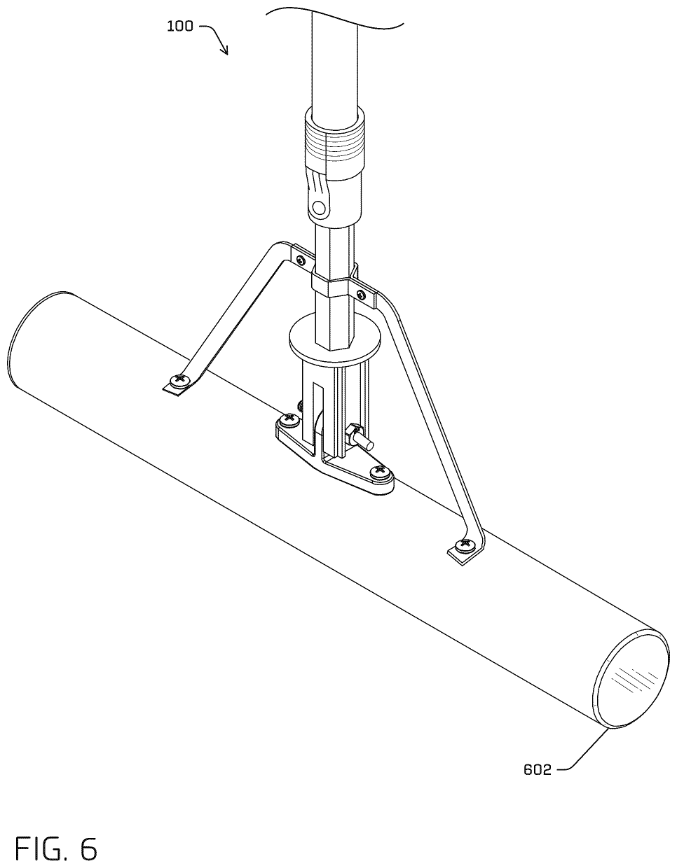

In some examples, a first terminal end 108a of the elongated head 104 and/or a second terminal end 108b of the elongated head 104 may be enclosed. For example, the first terminal end 108a and/or second terminal end 108b may comprise an end cap or similar fitting or component configured to seal or enclose the first terminal end 108a and/or the second terminal end 108b. Such a fitting or component may thereby reduce or eliminate the unwanted intrusion of material into the elongated head 104. Such enclosed terminal end(s) may also be due to the elongated head 104 being comprised of a solid material (or, e.g., a non-hollow material), as discussed above. In at least some examples, the first terminal end 108a and/or second terminal end 108b may comprise beveled, chamfered, or rounded edges, or may comprise a domed surface to reduce or eliminate the disturbances or lines that may otherwise be left by unenclosed terminal end(s). Such edges are discussed in more detail below with regard to FIG. 6.

In some examples, the elongated head 104 may comprise a cross sectional dimension (e.g., diameter) between 3 inches and 8 inches. Such a range of dimensions may provide a preferred coverage or surface area without sacrificing usability, convenience, or portability. Further, a cross sectional dimension between 3 inches and 8 inches may allow a user to apply example device 100 without fatigue or with minimal fatigue by providing a surface area to contact the material that does not introduce burdensome drag for the user. Further, such dimensions may avoid creating an unacceptable indents or disturbances in the material as it is used. For the sake of clarity and not limitation, an elongated head 104 with a cross sectional dimension less than 3 inches may provide insufficient surface area to efficiently and accurately level material, and/or an elongated head 104 with a cross sectional dimension greater than 8 inches may contact the material with too much surface area, which may increase the drag of the device and decrease its convenience and usability.

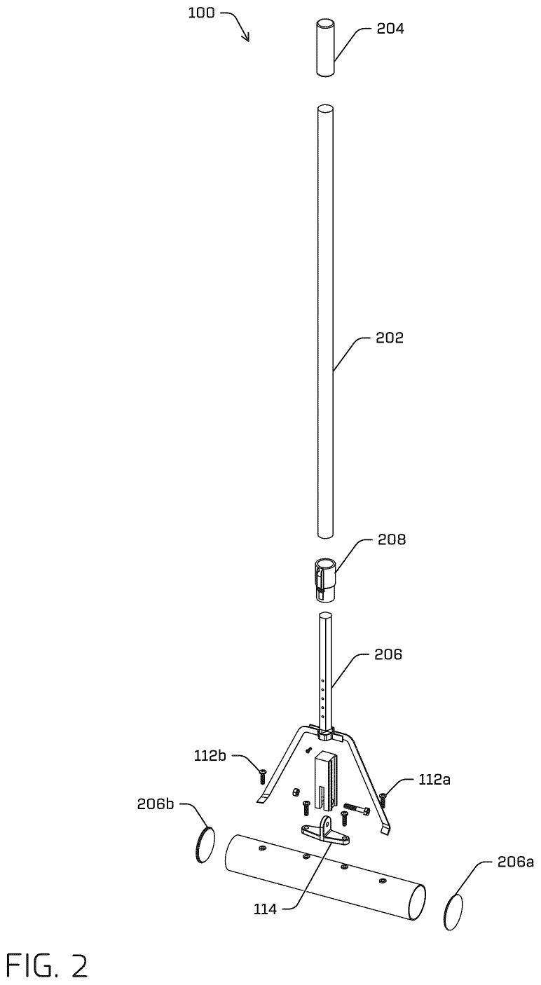

Example device 100 may further comprise an attachment mechanism to couple the elongated head 104 to the handle 102. The attachment mechanism may comprise a first brace 110a angularly coupled to the handle 102 and to a first portion of the elongated head 104 with a first fastener 112a, and/or a second brace 110b angularly coupled to the handle 102 and to a second portion of the elongated head 104 with a second fastener 112b. The first fastener 112a and second fastener 112b are discussed in more detail below with regard to FIG. 2. In some examples, the first portion may be positioned in the first longitudinal direction 106a and the second portion may be positioned in the second longitudinal direction 106b. Although depicted as comprising two braces, in some examples example device 100 may comprise three or more braces or less than two braces. For instance, in some examples, example device 100 may comprise zero angular braces, and instead the handle 102 may be coupled to the elongated head 104 by a single attachment point. In such an example, the single attachment point may couple a terminal end of the handle 102 to a medial portion of the elongated head 104 such that the handle 102 is at least partially orthogonally coupled to the elongated head 104 relative to a longitudinal axis of the elongated head 104. Such may be the case, for example, if the handle 102 is configured to hinge or tilt at an adjustable angle such that a user can manipulate the position that they use the example device 100. In other examples, the handle 102 may be coupled to the elongated head 104 using three or more braces, if, for example, the elongated head 104 has an ovular shape or cross section to increase the surface area that contacts the material. In such an example, the elongated head 104 comprising an ovular cross section may be better supported or may be more durable and resistant to wear and tear over time with three or more braces that may be positioned or coupled to the elongated head 104 in a triangular format/layout.

As depicted, example device 100 may comprise two braces configured to provide lateral support to the elongated head 104 by angularly coupling the elongated head 104 to the handle 102. The first brace 110a and second brace 110b may provide improved durability and resistance to wear and tear by providing structural support to the first longitudinal direction 106a and/or the second longitudinal direction 106b of the elongated head 104. The first brace 110a and second brace 110b may distribute the force (e.g., downward force, pull or push force) applied to the elongated head 104. In other words, as a user pushes or pulls the device, or presses the elongated head 104 downwards into the material (e.g., by applying force via the handle 102 or otherwise), the first brace 110a and second brace 110b may help distribute the force exerted more evenly across the elongated head 104, thereby increasing the durability and overall effectiveness of the device. The first brace 110a and/or the second brace 110b may be comprised of any one or more materials that the handle 102 or elongated head 104 may be comprised of, and each material may provide unique benefits for specific use cases or circumstances. For example, the first brace 110a and/or second brace 110b may comprise any one or more metal, wood, composite, plastic, as described herein, or any combination thereof.

In some examples, and as depicted in FIG. 1, the handle 102 may additionally or alternatively couple to the elongated head 104 at a medial attachment mechanism 114 positioned or aligned at a medial portion of the elongated head 104. Such a medial attachment mechanism 114 may, in some examples, be the only mechanism or location which couples the handle 102 to the elongated head 104. In some examples, the medial attachment mechanism 114 may comprise a pivot or similar mechanism configured to allow a user to adjust the vertical angle of the handle 102 relative to the elongated head 104. In other words, the handle 102 May be configured to pivot, hinge, or tilt such that the elongated head 104 maintains its surface area and angle as it contacts the material. Such functionality may improve the versatility of the device by allowing a user to customize the tilt/angle of the handle 102 to better suit their height, position, distance from the material, or other circumstances or preferences. The adjustable angle facilitated by the medial attachment mechanism 114 may reduce user fatigue and improve ergonomic comfort and control and may increase efficiency by maintaining the surface area and contact angle of the elongated head 104 for any given user(s). In other examples, the medial attachment mechanism 114 and one or more braces configured to provide lateral support to the elongated head 104 may be formed integrally as a single unitary attachment mechanism. For example, the medial attachment mechanism 114, the first brace 110a, the second brace 110b, and/or one or more additional angular braces may be fabricated or constructed as a single, unitary attachment mechanism. Such examples may decrease complexity of example device 100 by reducing the number of components subject to wear and tear and replacement, which may improve durability over time and/or may decrease the cost of manufacturing one or more devices.

FIG. 2 illustrates an exploded view of the example device 100 of FIG. 1, according to examples of the present disclosure. As depicted, the handle 102 of example device 100 may comprise a shaft 202, a grip 204, an extension component 206, and a locking mechanism 208. The extension component 206 may be configured to engage with, be received by, and/or be positioned in or around the locking mechanism 208 and/or the shaft 202. The locking mechanism 208 may be configured to receive one or more of the shaft 202 or the extension component 206 and lock or otherwise secure the handle 102 at a user's desired length. For example, as depicted, the extension component 206 may comprise a plurality of locking dimples or holes positioned at different intervals/locations along the extension component 206 and may be configured to receive a locking pin or similar fastening mechanism from the locking mechanism 208 to secure the extension component 206 at a specific length and to prevent unintended collapse or extension. There are myriad locking mechanism 208 designs and functionalities that may be used to secure a specific length of the handle 102. For example, a twist lock mechanism may allow a user to twist one or more of the shaft 202, extension component 206, and/or a locking collar (not shown) relative to one another to tighten the mechanism and thereby prevent movement, or a snap lock mechanism may allow a user to push or snap one or more of the shaft 202 or the extension component 206 into the mechanism using a spring loaded mechanism or detent to prevent slippage or movement. In some examples, the locking mechanism 208 may comprise a cam lock mechanism configured to allow a user to turn or twist a knob or similar lock mechanism to engage a cam mechanism that tightens against the extension component 206 or against the shaft 202 to secure it in place. In other examples, the locking mechanism 208 may comprise a spring button or similar clip that may be pressed to release or engage the extension component 206 or the shaft 202 and thereby secure the handle 102 at a desired length. In yet other examples, the locking mechanism 208 may comprise a magnetic locking mechanism configured to maintain the handle 102 at a user's preferred length. There are many locking mechanism 208 designs that may be employed for certain use cases or circumstances, all of which are contemplated herein. In some examples, devices according to this disclosure may have fixed length handles (e.g., handles that are not extendable) and in that case the device may omit a locking mechanism. In such examples, the handle 102 may not be adjustable, but the device may be more economical or affordable, may be lighter weight, may be easier to repair, or may be more durable due to fewer moving parts subject to wear and tear.

As discussed above, example device 100 may comprise one or more braces configured to couple the elongated head 104 to the handle 102 and to more evenly distribute forces exerted on the elongated head 104 by the material or by a user. In some examples, the braces(s) may be coupled to the elongated head 104 using one or more fasteners. For example, the first brace 110a may be coupled to the elongated head 104 with a first fastener 112a and/or the second brace 110b may be coupled to the elongated head 104 with a second fastener 112b. In some examples, the first fastener 112a and the second fastener 112b comprise the same kind of fastener, but in other cases may comprise different fasteners. In some examples, the first brace 110a and/or the second brace 110b may be fixedly coupled (fixed against pivoting or rotation) to the elongated head 104, while in some examples the first brace 110a and/or the second brace 110b may be movably coupled (e.g., pivotably, slidably, etc.) to the elongated head by one or more hinges, ball joints, slides, or other movable attachment mechanisms. The first fastener 112a and/or second fastener 112b may comprise any one or more of a jacknut, a bolt, a nut, a screw, a rivet, a clip (e.g., spring clip, retaining clip, snap clip, etc.), a pin, a clamp, a washer, a weld, a ball and socket joint, slots, slides, or any combination thereof. For example, a bolt and a nut together may comprise the first fastener 112a to secure the first brace 110a to the elongated head 104, and a rivet may comprise the second fastener 112b to secure the second brace 110b to the elongated head 104. In some examples, the first fastener 112a and/or second fastener 112b may comprise a bolt or screw, and a jacknut (sometimes called a captive nut or captive screw), which may be positioned on an interior surface of the elongated head 104 and be configured to receive the bolt or screw. The bolt or screw may engage with the jacknut, where then the jacknut may expand or set securely against an interior surface/wall of the elongated head 104. Such a configuration may increase durability and resistance to wear and tear by preventing any pressure points inside or outside of the elongated head 104 that may be introduced by some fasteners depending on the shape or design of the elongated head 104. As a nonlimiting example, a round, circular, or ovular cross section shape of the elongated head 104 may mean that a conventional bolt and nut do not lay flat against an interior and/or exterior surface of the elongated head 104, thereby introducing pressure or stress points and decreasing the durability or longevity of the device. In other examples, the elongated head 104 may be manufactured or designed with a flat surface where the first fastener 112a and/or the second fastener 112b are configured to contact a surface of the elongated head 104.

As discussed above, example device 100 may comprise a medial attachment mechanism 114 that may, in addition to or in lieu of the first brace 110a and/or second brace 110b, be configured to couple the handle 102 to the elongated head 104. As discussed above and as shown in FIG. 2, the medial attachment mechanism 114 may comprise one or more first components coupled to the elongated head 104 and one or more second components coupled to the handle 102 that may integrate with, receive, or otherwise be configured to couple to the one or more first components. In some examples, the medial attachment mechanism 114 may comprise one or more fasteners (e.g., screws, nuts, bolts, rivets, etc.), an adhesive bond, a snap fit joint, a clamp, a knuckle bracket, a hinge joint, a ball and socket joint, a weld, or any combination thereof. Some medial attachment mechanism 114 designs may allow a user to tilt or angle the handle on a horizontal and/or vertical axis relative to a longitudinal axis of the elongated head 104. For example, a ball and socket joint may increase usability, convenience, and comfort by allowing a user to level material at an indirect or off-center angle. Such may be the case, for example, in the context of sand traps/bunkers on a golf course where a user may not have a direct or straight-on approach to the unlevel sand and may be forced to level the material with example device 100 from an oblique or askew angle. In such an example, a ball and socket joint may allow the user to level the sand in the bunker from the oblique or askew angle effectively and conveniently. As depicted by FIG. 2, the medial attachment mechanism 114 may in some examples comprise a hinge joint, ball joint, or other pivotable connection point. Such a medial attachment mechanism 114 may allow a user of any height or position to effectively and efficiently level material. For example, in the context of leveling sand in a track and field sand pit, a referee, volunteer, or spectator who may be sitting in a chair can adjust the angle of the hinge joint to ensure efficient and accurate leveling of the material without having to stand up or otherwise reposition themselves between jumps. Such a functionality may reduce the time and energy it takes to level the material between disturbances or instances, and thereby improve the flow or schedule of the competition. In other examples, the medial attachment mechanism 114 may fixedly couple the handle 102 to the elongated head 104 to reduce manufacturing or consumer costs, improve durability, and/or increase efficiency. For example, a weld or an adhesive bond may reduce the manufacturing complexities, thereby reducing the cost of manufacture and to a consumer, may improve durability by reducing the number of moving parts subject to wear and tear over time, and may increase efficiency by ensuring that a user of any height, position, or circumstance can use the tool without having to worry about adjusting settings, angles, lengths, etc. of the device.

In some examples, as discussed above, a first terminal end 108a and/or a second terminal end 108b of the elongated head 104 may be enclosed. As depicted in FIG. 2, the first terminal end 108a may be enclosed with a first cap 206a and/or the second terminal end 108b may be enclosed with a second cap 206b. The first cap 206a and second cap 206b may be configured to prevent material from entering the elongated head 104 but may still allow a user to access the interior of the elongated head 104 to tighten, loosen, or remove the first fastener 112a or second fastener 112b, to remove material, to add or remove weight to better suit the circumstances of a specific use case, and so on. In other examples, the first cap 206a and/or second cap 206b may not be separate components, and instead the elongated head 104 may be enclosed by virtue of being a solid material and/or lacking hollow terminal ends. For example, if the elongated head 104 is designed or manufactured using an injection or similar molding process, the elongated head 104 may lack the open terminal ends but may still have a hollow interior. In another nonlimiting example, the elongated head 104 may be comprised of a solid material (e.g., steel, wood) and therefore may lack a hollow interior. In such an example, the solid material construction of the elongated head 104 may lack open terminal ends with which a first cap 206a and/or second cap 206b may engage to enclose.

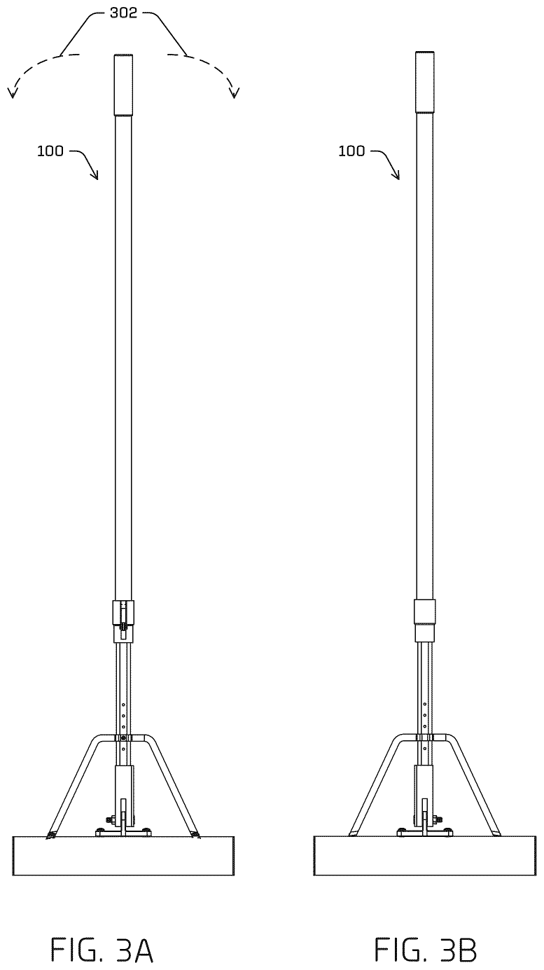

FIG. 3A illustrates a horizontal frontal view and FIG. 3B illustrates a horizontal rear view of example device 100, according to examples of the present disclosure. For the sake of context and clarity and not limitation, horizontal directional arrows 302 depict the hinge/tilt angle of the handle 102 in at least some examples. As discussed above, some medial attachment mechanism 114 designs or functionalities (e.g., ball and socket joint, etc.) may allow a user to hinge or tilt the handle 102 horizontally relative to a longitudinal axis of the elongated head 104 such that a grip 204 or terminal end the handle 102 in the first direction pendulates or moves in an arc relative to the longitudinal axis of the elongated head 104. In such examples, if example device 100 comprises a first brace 110a, a second brace 110b, and/or one or more additional braces, such brace(s) may telescope or extend/collapse as the handle 102 is hinged/tilted horizontally. For example, in such examples, the first brace 110a and/or second brace 110b may comprise a piston (e.g., hydraulic, pneumatic, spring loaded, etc.) or other telescoping support brace configured to assist movement to encourage horizontal hinge/tilt or resist movement such that the handle tends to return to its original position relative to the longitudinal axis of the elongated head (e.g., perpendicular, at least partially orthogonal). In other examples, the locking mechanism 208 and/or an attachment point where the first brace 110a and/or the second brace 110b couple to the handle may be configured to slide along the length of the handle 102 to allow the handle 102 to hinge/tilt horizontally. In some examples, as discussed above, a device may lack a first brace 110a and a second brace 110b and may instead comprise a single medial attachment mechanism 114. In such an example, the handle 102 may not be restricted or limited in its horizontal movement. Such horizontal movement or functionality may at least improve usability from various angles or positions.

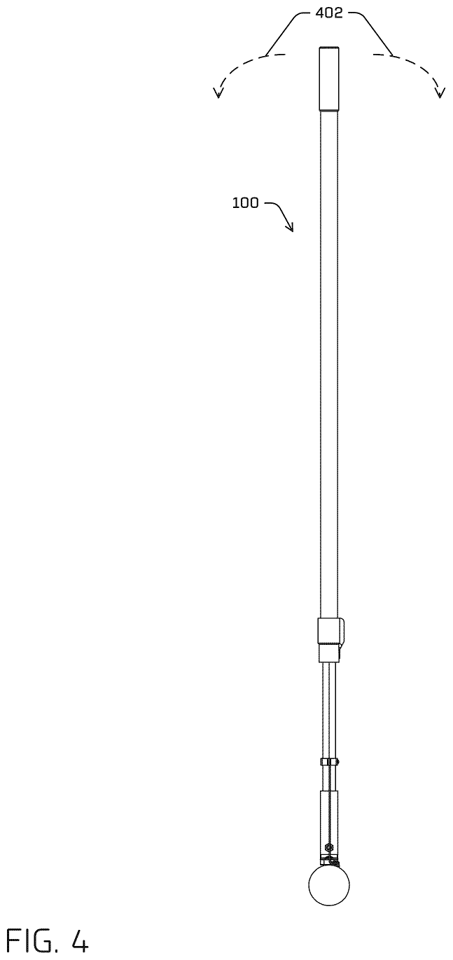

FIG. 4 illustrates a horizontal side view of example device 100, according to examples of the present disclosure. For the sake of context and clarity and not limitation, vertical directional arrows 402 depict the hinge/tilt angle of the handle 102 in at least some examples. As discussed above, one or more medial attachment mechanism 114 designs or functionalities (e.g., ball and socket joint, hinge joint, knuckle joint, etc.) may allow the handle to hinge or tilt perpendicularly or orthogonally relative to a longitudinal axis of the elongated head 104. Such movement or functionality may improve usability from various angles or positions. Depending on the medial attachment mechanism 114, such movement or functionality may be in addition to or in lieu of the hinge/tilt depicted by horizontal directional arrows 302.

In some examples, the elongated head 104 may comprise a hollow material or shape. In other examples, the elongated head 104 may comprise a solid material, or may comprise a hollow material enclosed on one or more of the first terminal end 108a or second terminal end 108b with a cap or otherwise, as discussed above.

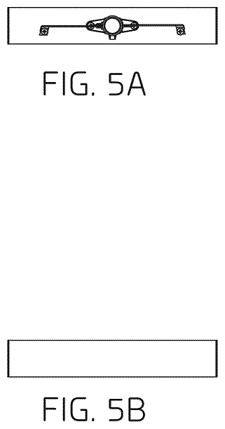

FIG. 5A illustrates a top-down view and FIG. 5B illustrates a bottom-up view of example device 100, according to examples of the present disclosure.

FIG. 6 illustrates an enlarged view of an elongated head of example device 100, according to examples of the present disclosure. As depicted by FIG. 6, in some examples one or more of the terminal ends 602 of the elongated head 104 may comprise a beveled, chamfered, or similarly rounded edge. In other examples, one or more of the terminal ends 602 of the elongated head 104 may comprise a domed surface. Such an edge or surface design of the terminal ends 602 may reduce or eliminate lines or disturbances that may be left in the material by harsh, sharp, or similarly abrupt angles found on conventional devices. For example, in the context of a sand pit in track and field, where a smooth and level surface is important to the accuracy of measuring the distance jumped, any line, disturbance, or imperfection not leveled or smoothed out could be the difference between winning and losing, breaking or missing a record, and so on. In such an example, the chamfered, beveled, or rounded edge, or domed surface of one or more of the terminal ends 602 of the elongated head 104 may help ensure a meticulously and thoroughly leveled, smooth surface. Such an edge or surface design may further improve the usability and convenience of example device 100 because, for example, a novice user of the device may be less prone to leaving lines or disturbances or may require less training in order to properly level the material in between athletes or instances. Further, such an edge or surface design may improve the aesthetic quality of a sand trap on a golf course, for example, by reducing or eliminating disturbances or imperfections left behind in the sand by a device that may have abrupt edges.

FIG. 7 illustrates example device 100, according to examples of the present disclosure. As shown, in some examples, the elongated head 104 may comprise a medial housing 702, a first body 704a, and/or a second body 704b. The first body 704a may be configured to extend in the first longitudinal direction 106a and/or the second body 704b may be configured to extend in the second longitudinal direction 106b. The medial housing 702 may be configured to receive or engage with the first body 704a and/or the second body 704b. As depicted for the sake of clarity, the first body 704a and the second body 704b may be configured to slide or move parallel to the longitudinal axis of the elongated head 104 along an interior surface of the medial housing 702. In some examples, a first fastening mechanism 706a may be configured to secure the first body 704a in place and a second fastening mechanism 706b may be configured to secure the second body 704b in place. The first fastening mechanism 706a and/or the second fastening mechanism 706b may comprise one or more of set screw(s), pin(s), clamp(s), collar(s), cam lock(s), threaded lock nut(s) and bolt(s), or any other mechanism similarly configured to engage with and secure the first body 704a and/or second body 704b. There are myriad fastening mechanisms that may be employed to secure the elongated head 104 at a user's determined width. For example, a twist lock mechanism may allow a user to twist one or more of the first body 704a or second body 704b relative to the medial housing 702 in order to tighten the mechanism(s) and thereby prevent movement. In other examples, a snap lock mechanism may allow a user to push or snap one or more of the first body 704a and/or second body 704b into the snap lock mechanism or medial housing 702 using a spring-loaded mechanism or detent in order to prevent slippage or movement. In yet other examples, a cam lock mechanism may allow a user to turn or twist a knob or similar lock mechanism configured to engage with the first body 704a and/or second body to secure the first body 704a and/or second body 704b against the medial housing 702 and thereby prevent unwanted extension or collapse. In yet other examples, the first fastening mechanism 706a and/or the second fastening mechanism 706b may comprise a magnetic locking mechanism configured to maintain the elongated head 104 at a user's preferred length. In the depicted example for the sake of clarity and not limitation, the first fastening mechanism 706a and the second fastening mechanism 706b comprise set screws configured to extend through the medial housing 702 by a user and to engage/tighten the first body 704a and second body 704b, respectively, thereby securing them at a determined/desired position.

In some examples, the first body 704a and/or second body 704b may be configured to receive the medial housing 702 such that the medial housing slides or moves in and out of the first body 704a and/or second body 704b. In other words, the medial housing 702 may be configured to insert into the first body 704a and/or second body 704b. In such an example, a spring button, pin, or similar clip may be pressed to release or engage the first body 704a and/or second body 704b to the medial housing 702 and thereby secure the elongated head 104 at a specified/determined longitudinal width.

In some examples, as discussed above, the handle 102 may comprise measurement indicators 708 at regular intervals (e.g., any combination of one or more of imperial units, metric units, etc.). Such measurement indicators 708 may be used by an individual to measure a distance of their own practice, training, or competition long jump, for example. In another nonlimiting example, the measurement indicators 708 may allow a user to determine a distance or measurement from a stake/peg that one or more horseshoes landed after a toss, may assist a golfer determine how high they should chip their ball to successfully exit a sand trap/bunker, and so on.

In some examples, example device 100 may be a first device, and one or more second devices may be configured to couple laterally to example device 100 to increase the surface area that contacts the material. For example, the attachment mechanism 114 of a first device may be configured to couple to a second attachment mechanism of a second device such that the longitudinal axis of the elongated head of the first device at least partially aligns with the longitudinal axis of the elongated head of the second device, thereby increasing the surface area that contacts the material. In other examples, the first terminal end 108a and/or the second terminal end 108b of the first device may comprise a lateral attachment mechanism configured to couple to a terminal end of a second device which may also comprise a second lateral attachment mechanism. Two or more laterally coupled devices may increase the overall width and allow a user to contact a greater surface area that a single device would. As a more concrete example, a rodeo may have a pit area that is too big for a single device to efficiently level and coupling two or more device(s) laterally may allow a user or machine to more effectively and efficiently level the material.

FIGS. 8A, 8B, and 8C illustrate alternative elongated head 104 examples of example device 100, according to examples of the present disclosure. Although referred to herein as “elongated head 104,” the head or contact surface area of any given example device 100 may comprise a cylindrical shape, any one or more of the shapes depicted by FIG. 8A, 8B, or 8C, and/or any combination thereof. For example, FIG. 8A depicts an example device 100 with an elongated head 104 that comprises an arcuate cross section. Such an example device 100 may be less costly to manufacture, may be easier to repair or replace, may be lighter and more compact to reduce user fatigue and improve comfort, and so on. In another example, FIG. 8B depicts an example device 100 with an elongated head 104 comprising a semi-cylinder or partially cylindrical cross section. In yet another example, FIG. 8C depicts an example device 100 with an elongated head 104 that comprises an offset semi-cylinder or partially cylindrical cross section. Various use cases or circumstances may employ myriad elongated head 104 designs or shapes, each of which is contemplated herein. An ordinarily skilled artisan will appreciate that the elongated head 104 may comprise any one or more of the shapes or cross-sectional designs depicted, discussed, and/or contemplated herein, or any combination thereof.

FIGS. 9A and 9B illustrate alternative examples of the elongated head 104 of example device 100, according to examples of the present disclosure. There are myriad surface contours, designs, textures, or reliefs that may comprise the elongated head 104 which may provide various benefits depending on specific circumstances, materials, use cases, costs, etc. For example, FIG. 9A depicts an elongated head 104 comprising a corrugated outer surface contour. Such an elongated head 104 may improve the aesthetic quality of a sand trap of a golf course, for example. Although depicted in FIG. 9A as having corrugations that are slightly angled/tilted, in some examples the corrugations or grooves may be oriented vertically such that the elongated head may be configured to leave straight or linear indentations or furrows in the material. In at least one example, the elongated head 104 comprising corrugations or spirals, as depicted by FIG. 9A, may comprise one or more inner sleeves or bodies configured to thread into an outer sleeve or body. In such an example, the elongated head 104 may be extended by rotating or turning one or more of the inner sleeves or outer sleeve relative to the other. Such a functionality may allow a user to extend the width of the elongated head 104 without introducing fastener mechanism(s) that may be subject to wear and tear or otherwise increase the complexity and/or cost of the device. Such corrugations may be a desired aesthetic of a sand trap/bunker on a golf course or for a bocce ball court, for example. FIG. 9B depicts an elongated head 104 comprising dimples raised from the exterior surface of the elongated head 104. In some examples, elongated head 104 may comprise a studded outer contour. In other examples, the dimples may be indented or recessed rather than protrude from the exterior surface of the elongated head 104. In some examples, elongated head 104 may comprise holes or open horizontal or vertical slits/apertures to allow material to flow or travel through the elongated head 104, which may thereby reduce drag of the material against the elongated head 104 and improve usability/efficiency. As a nonlimiting concrete example, an outer surface contour comprising holes may allow more efficient and effective use for material with a substantial water content, as the material may still be leveled effectively and efficiently while the water travels through the device. Such a feature may reduce the drag of the device as it is applied to the material and may prevent pooling water in certain areas and/or interrupting the smooth, level material by unintentionally distributing water along with material.

As discussed above and as shown in at least FIG. 1, the elongated head 104 may comprise a smooth outer contour such that example device 100 distributes and levels material smoothly, without any disturbances or patterns left in the material. Various use cases or circumstances may employ myriad surface contours, designs textures, and/or reliefs, each of which is contemplated herein. An ordinarily skilled artisan will appreciate that the elongated head 104 may comprise any one or more of the surface contours, designs, textures, and/or reliefs that are depicted, discussed, and/or contemplated herein, or any combination thereof.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The specific configurations, choice of materials, and size and shape of various elements are meant to be illustrative for the sake of clarity and can be varied according to any particular design specifications or constraints required of a device, system, or method constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

Conjunctive language such as the phrase “at least one of X, Y or Z,” unless specifically stated otherwise, is to be understood to present that an item, component, etc. may be either X, Y, or Z, or any combination thereof, including multiples of each element. Unless explicitly described as singular, “a” means singular and plural. When referring to a collection or set of items, components, or options, it should be understood that the definition may include, but is not limited to, the common understanding of the term in mathematics to include any number of items including a null set (0), 1, 2, 3, . . . up to and including an infinite set.

Many variations and modifications may be made to the above-described examples, the elements of which are to be understood as being among other acceptable examples. All such modifications and variations are intended to be included herein within the scope of this disclosure and protected by the following claims.

What is claimed is:

1. A device for leveling material, comprising:
an extendible handle extending in a first direction;
a cylindrical head comprised of polyvinyl chloride or acrylonitrile butadiene styrene orthogonally coupled to the extendible handle, wherein the cylindrical head extends in a first longitudinal direction and a second longitudinal direction opposite the first longitudinal direction and comprises:
a first terminal end in the first longitudinal direction comprising a first cap with a first radiused edge;
a second terminal end in the second longitudinal direction comprising a second cap with a second radiused edge;
a cross sectional diameter between 3 and 6 inches;
a length between the first terminal end and the second terminal end between 24 inches and 36 inches; and
a smooth outer contour configured to contact and distribute the material;
an attachment mechanism to couple the cylindrical head to the extendible handle, the attachment mechanism comprising:
a center support coupled to a medial portion of the cylindrical head;
a first side support angularly coupled to a first portion of the cylindrical head with a first fastener;
a second side support angularly coupled to a second portion of the cylindrical head with a second fastener, wherein the first portion is positioned in the first longitudinal direction and the second portion is positioned in the second longitudinal direction.

2. The device of claim 1, wherein the cylindrical head comprises a first extension body configured to extend in the first longitudinal direction and a second extension body configured to extend in the second longitudinal direction.

3. The device of claim 1, wherein the extendible handle comprises measurement indicators to allow a user to measure a length using the extendible handle.

4. A device comprising:
a handle extending in a first direction;
an elongated head having at least a partially cylindrical cross section, wherein the elongated head extends in a first longitudinal direction and a second longitudinal direction opposite the first longitudinal direction, wherein a surface of the elongated head is configured to contact and distribute a material; and
an attachment mechanism to couple the elongated head to the handle, the attachment mechanism comprising:
a first brace angularly coupled to the handle and to a first portion of the elongated head with a first fastener; and
a second brace angularly coupled to the handle and to a second portion of the elongated head with a second fastener, wherein the first portion is positioned in the first longitudinal direction and the second portion is positioned in the second longitudinal direction.

5. The device of claim 4, wherein the elongated head comprises one or more of:
aluminum;
acrylonitrile butadiene styrene;
carbon fiber;
polyvinyl chloride; or
fiberglass.

6. The device of claim 4, wherein one or more of a first terminal end of the elongated head or a second terminal end of the elongated head opposite the first terminal end comprise a chamfered edge, a radiused edge, or a domed surface to prevent the elongated head from leaving a disturbance in the material.

7. The device of claim 6, wherein one or more of the first terminal end of the elongated head or the second terminal end of the elongated head is enclosed.

8. The device of claim 4, wherein the attachment mechanism further comprises one or more of:
a fastener;
an adhesive bond;
a snap fit joint;
a clamp;
a knuckle bracket;
a hinge joint;
a ball and socket joint; or
a weld.

9. The device of claim 4, wherein the attachment mechanism is coupled to the elongated head at an adjustable vertical angle relative to a longitudinal axis of the elongated head to improve user comfort and usability.

10. The device of claim 4, wherein the handle is aligned with a center portion along a longitudinal axis of the elongated head and extends orthogonally relative to the longitudinal axis of the elongated head.

11. The device of claim 4, wherein the elongated head comprises one or more of:
a smooth outer contour;
a corrugated outer contour;
dimpled outer contour; or
studded outer contour.

12. The device of claim 4, wherein one or more of the first fastener or the second fastener comprise one or more of:
a jacknut;
a bolt;
a rivet, or
a weld.

13. The device of claim 4, wherein the elongated head further comprises:
a medial housing to which the attachment mechanism is coupled;
a first body configured to engage with a first end of the medial housing and extend in the first longitudinal direction; and
a second body configured to engage with a second end of the medial housing opposite the first end and extend in the second longitudinal direction.

14. The device of claim 13, further comprising:
a first fastening mechanism configured to secure the first body in place; and
a second fastening mechanism configured to secure the second body in place.

15. The device of claim 4, wherein the handle is configured to extend in the first direction to increase a length of the handle.

16. The device of claim 4, wherein the handle comprises measurement indicators at regular intervals along a length of the handle.

17. The device of claim 4, wherein the handle comprises one or more of:
wood;
aluminum;
steel;
high-density polyethylene; or
composite.

18. The device of claim 4, wherein the elongated head is a first elongated head, the device comprising one or more second elongated heads configured to couple laterally to the first elongated head to increase a width of the surface configured to contact and distribute the material.

19. The device of claim 4, wherein the elongated head has a width between 18 inches and 36 inches.

20. The device of claim 4, wherein the elongated head has a cross-sectional diameter between 3 inches and 8 inches.
